(19) United States
(12) Patent Application Publication
(10) Pub. No.: US 2026/0285591 A1
(43) Pub. Date: Sep. 24, 2026

(54) AUTOMATED GARBAGE CAN DEVICE

(71) Applicants: Nicholas Mahler, Granada Hills, CA (US); Nancy Mahler, Granada Hills, CA (US)

(72) Inventors: Nicholas Mahler, Granada Hills, CA (US); Nancy Mahler, Granada Hills, CA (US)

(21) Appl. No.: 19/083,794

(22) Filed: Mar. 19, 2025

(51) Int. Cl. B65F 1/14; B60L 53/12; B60L 53/30; B65F 1/06; B65F 1/16; H02J 50/10

(52) U.S. Cl. CPC B65F 1/1473; B60L 53/12; B60L 53/30; B65F 1/06; B65F 1/1646; B65F 2210/128; B65F 2210/165; B65F 2210/168; H02J 50/10

(57) ABSTRACT

An automated garbage can device includes a garbage can and a plurality of rollers rotatably coupled to the garbage can for rolling along a support surface to transport the garbage can along the support surface. A plurality of motors is each in mechanical communication with a respective one of the plurality of rollers. A respective motor rotates the respective roller in a forward direction or a rearward direction such that the garbage can travels toward a collection spot or toward a home position. A camera is coupled to the garbage can to capture imagery along the direction of travel of the garbage can. A charging unit is mountable to a structural support and the charging unit broadcasts a charging signal. A plurality of charging plates is coupled to the garbage can. A respective one of the charging plates abuts against the charging unit for charging the garbage can.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garbage can device and more particularly pertains to a new garbage can device for automatically transporting a garbage can between a collection spot and a home position. The device includes a garbage can and a plurality of motorized rollers which drive the garbage can along a support surface and a camera integrated into the garbage can and an image analysis module for analyzing imagery from the camera for steering the garbage can. The device includes a charging unit that is mounted to support structure and a plurality of charging plates which are coupled to the garbage can for wirelessly charging the garbage can.

### (2) Description of Related Art Including Information Disclosed Under 37 CFR 1.97 and 1.98

The prior art relates to garbage can devices including: a motorized cart device that includes a motorized cart and a ground laid wire and a sensor attached to the motorized cart for sensing the ground laid wire; a variety of autonomous garbage can devices that each at least includes a motorized cart that can carry a garbage can and which includes motion control hardware and software for automatically driving the motorized cart; a remotely controlled garbage can device that includes a motorized garbage can and a remote control for remotely controlling the motorized garbage can. In no instance does the prior art disclose an automated garbage can device that includes a motorized garbage can and an extrinsic electronic device for remotely controlling the motorized garbage can and a charging unit that is mountable to a support structure and a plurality of charging panels attached to the garbage can for wireless charging the garbage can from the charging unit.

### BRIEF SUMMARY OF THE INVENTION

An embodiment of the disclosure meets the needs presented above by generally comprising a garbage can and a plurality of rollers rotatably coupled to the garbage can for rolling along a support surface to transport the garbage can along the support surface. A plurality of motors is each in mechanical communication with a respective one of the plurality of rollers. A respective motor rotates the respective roller in a forward direction or a rearward direction such that the garbage can travels toward a collection spot or toward a home position. A camera is coupled to the garbage can to capture imagery along the direction of travel of the garbage can. A charging unit is mountable to a structural support and the charging unit broadcasts a charging signal. A plurality of charging plates is coupled to the garbage can. A respective one of the charging plates abuts against the charging unit for charging the garbage can.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an automated garbage can device according to an embodiment of the disclosure.

FIG. 2 is a back phantom view of an embodiment of the disclosure.

FIG. 3 is a right side phantom view of an embodiment of the disclosure.

FIG. 4 is a bottom phantom view of an embodiment of the disclosure.

FIG. 5 is a perspective in-use view of an embodiment of the disclosure.

FIG. 6 is a perspective in-use view of an embodiment of the disclosure showing a plurality of garbage cans being daisy chained for charging.

FIG. 7 is a schematic view of an embodiment of the disclosure.

FIG. 8 is a perspective view of a charging unit of an embodiment of the disclosure.

### DETAILED DESCRIPTION OF THE INVENTION

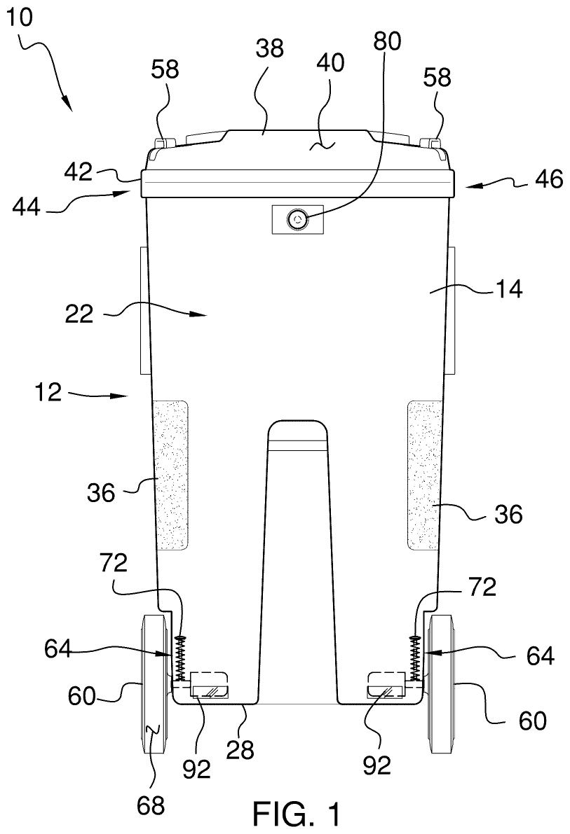

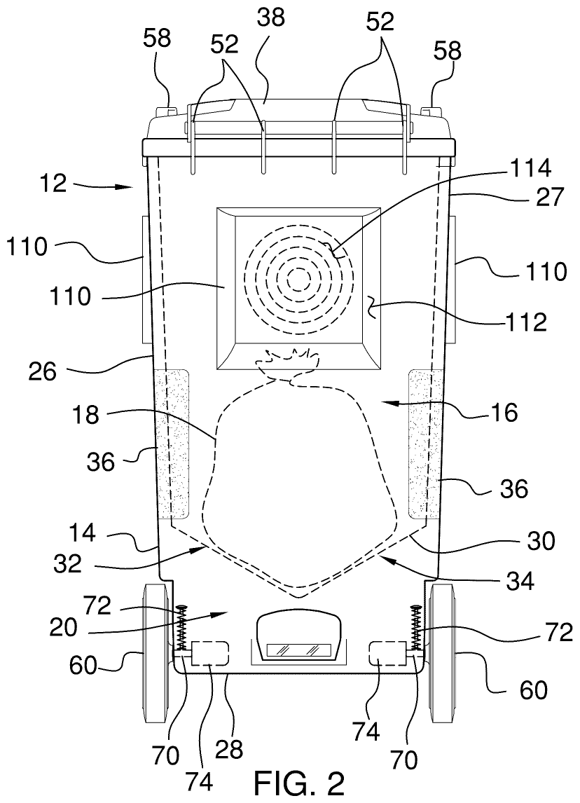

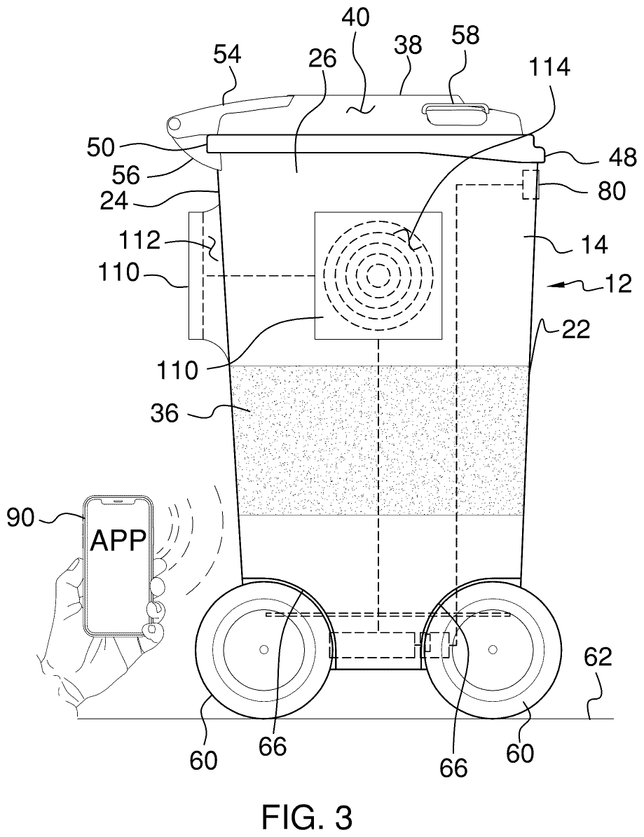

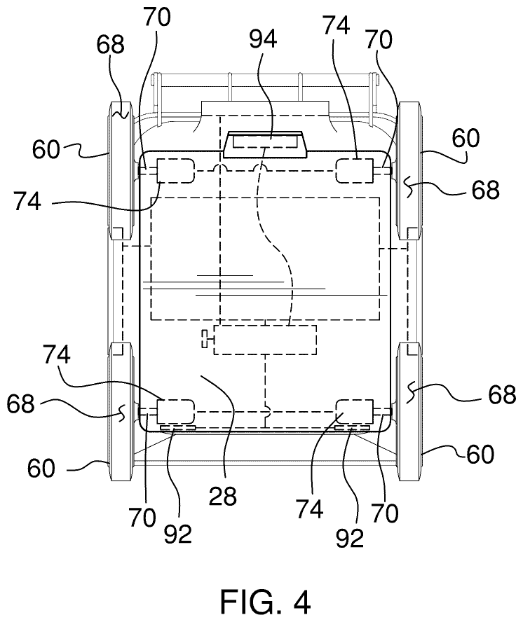

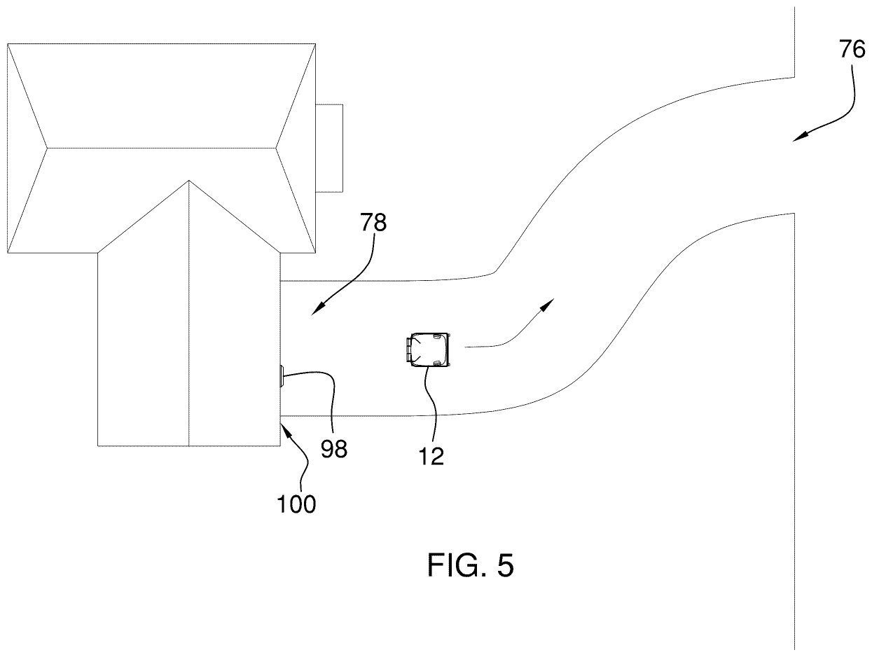

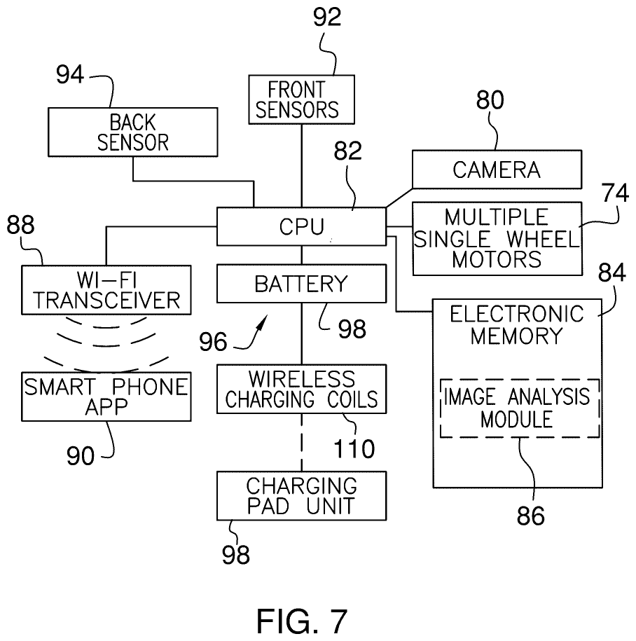

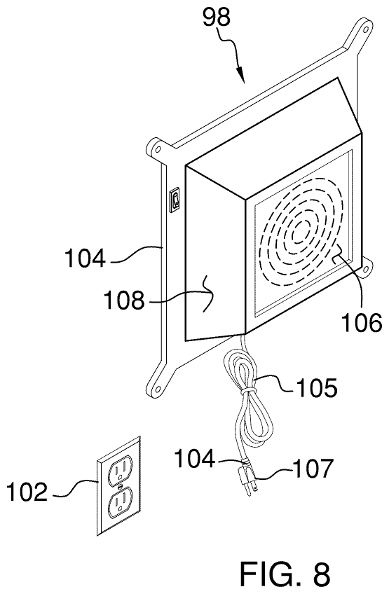

With reference now to the drawings, and in particular to FIGS. 1 through 8 thereof, a new garbage can device embodying the principles and concepts of an embodiment of the disclosure and generally designated by the reference numeral 10 will be described.

As best illustrated in FIGS. 1 through 8, the automated garbage can device 10 generally comprises a garbage can 12 which has an outer wall 1 second lateral side 274 defining an interior space 16 of the garbage can 12 to contain a garbage bag 18. The garbage can 12 has an electronics space 20 which is defined beneath the interior space 16. Furthermore, the electronics space 20 is fluidly discrete from the interior space 16. The outer wall 14 has a front side 22 and a back side 24 and a first lateral side 26 and a second lateral side 27 and the garbage can 12 has a bottom wall 28.

The interior space 16 has a lower bounding surface 30 and the lower bounding surface 30 is spaced upwardly from the bottom wall 28. The lower bounding surface 30 has a first side 32 intersecting a second side 34. The first side 32 slopes downwardly from the first lateral side 26 of the outer wall 14 toward the bottom wall 28. Additionally, the second side 34 slopes downwardly from the second lateral side 27 of the outer wall 14 toward the bottom wall 28. The first side 32 and the second side 34 intersect at a point which extends between the front side 22 and the back side 24 of the outer wall 14. Additionally, the electronics space 20 is defined between the bottom wall 28 and the lower bounding surface 30 of the interior space 16.

A pair of cushions 36 is each integrated into the outer wall 14 of the garbage can 12. Each cushion 36 of the pair of cushions 36 is positioned on a respective one of the first lateral side 26 or the second lateral side 27 of the outer wall 14. Additionally, each cushion 36 of the pair of cushions 36 extends partially around the front side 22 and the back side 24 of the outer wall 14 of the garbage can 12. Each cushion 36 of the pair of cushions 36 is oriented to extend along a line is oriented parallel to the bottom wall 28 of the garbage can 12. Each cushion 36 of the pair of cushions 36 is comprised of a resiliently compressible material, including but not being limited rubber or silicone, to absorb impact energy when the garbage can 12 strikes against an object.

A lid 38 is provided and the lid 38 is hingedly coupled to the garbage can 12. The lid 38 is positionable between an open position exposing the interior space 16 of the garbage can 12 or a closed position closing the interior space 16. The lid 38 has a top surface 40 and an outer edge 42 and the outer edge 42 has a first sidelong side 44 and a second sidelong side 46 each extending between a forward side 48 and a rear side 50. The lid 38 includes a plurality of hinges 52 and each hinge 52 of the plurality of hinges 52 includes a first portion 54 which is coupled to the top surface 40 of the lid 38 and a second portion 56 which is coupled to the back side 24 of the outer wall 14 of the garbage can 12. Additionally, the first portion 54 of each hinge 52 of the plurality of hinges 52 extends away from the rear side 50 of the outer edge 42 of the lid 38.

A pair of lid handles 58 is each coupled to the lid 38 for opening or closing the lid 38. Each lid handle 58 of the pair of lid handles 58 is positioned on the top surface 40 of the lid 38. Furthermore, each lid handle 58 of the pair of lid handles 58 is positioned adjacent to a respective one of the first sidelong side 44 and the second sidelong side 46 of the outer edge 42 of the lid 38. Each lid handle 58 of the pair of lid handles 58 is positioned proximate an intersection between the forward side 48 of the outer edge 42 of the lid 38 and the respective first sidelong side 44 or the second sidelong side 46 of the outer edge 42 of the lid 38 and the pair of lid handles 58 is oriented to angle toward each other.

A plurality of rollers 60 is provided and each roller 60 of the plurality of rollers 60 is rotatably coupled to the garbage can 12. Each roller 60 of the plurality of rollers 60 can roll along a support surface 62 to transport the garbage can 12 along the support surface 62. The support surface 62 may be a driveway at a residence, for example, the ground or other type of generally horizontal support surface. The outer wall 14 of the garbage can 12 has a plurality of wheel wells 64 and each wheel well 64 of the plurality of wheel wells 64 is recessed into a respective one of the first lateral side 26 and the second lateral side 27 of the outer wall 14 of the garbage can 12. Each wheel well 64 of the plurality of wheel wells 64 intersects a respective one of the front side 22 and the back side 24 of the outer wall 14 of the garbage can 12. Each roller 60 of the plurality of rollers 60 may comprise an inflatable rubber tire or other similar type of roller that can roller over uneven terrain.

Each wheel well 64 of the plurality of wheel wells 64 has a bounding surface 66. Furthermore, the bounding surface 66 curves between the bottom wall 28 of the garbage can 12 and the respective front side 22 or the back side 24 of the outer wall 14 of the garbage can 12. Each roller 60 of the plurality of rollers 60 is located in a respective one of the plurality of wheel wells 64 and each roller 60 of the plurality of rollers 60 has a rolling surface 68. The rolling surface 68 of a respective roller 60 is continuously arcuate about a rotational axis of the respective roller 60 such that the rolling surface 68 can roll along the support surface 62. The rolling surface 68 of each roller 60 of the plurality of rollers 60 is oriented co-arcuate with the bounding surface 66 of the respective wheel well 64.

A plurality of axles 70 is each rotatably coupled between the outer wall 14 of the garbage can 12 and a respective one of the plurality of rollers 60. Each axle 70 of the plurality of axles 70 is spaced upwardly from the bottom wall 28 of the garbage can 12. Furthermore, the rolling surface 68 of each roller 60 of the plurality of rollers 60 curves downwardly beyond the bottom wall 28 of the garbage can 12 such that the bottom wall 28 is elevated above the support surface 62. Each axle 70 of the plurality of axles 70 has a rotational axis which is oriented parallel to the bottom wall 28 of the garbage can 12 and each axle 70 of the plurality of axles 70 defines the rotational axis of the respective roller 60.

A plurality of shock absorbers 72 is provided and each shock absorber 72 of the plurality of shock absorbers 72 is integrated into the bottom wall 28 of the garbage can 12. Each shock absorber 72 of the plurality of shock absorbers 72 is coupled to a respective one of the plurality of axles 70. Furthermore, each shock absorber 72 of the plurality of shock absorbers 72 is oriented perpendicular to the bottom wall 28 of the garbage can 12. Each axle 70 of the plurality of axles 70 is movably upwardly or downwardly on the garbage can 12. Additionally, the plurality of shock absorbers 72 reduce bouncing when the plurality of rollers 60 either rolls over objects on the support surface 62 or rolls through depressions on the support surface 62.

A plurality of motors 74 is provided and each motor 74 of the plurality of motors 74 is integrated into the garbage can 12. Each motor 74 of the plurality of motors 74 is in mechanical communication with a respective one of the plurality of rollers 60. Additionally, each motor 74 of the plurality of motors 74 is positioned in the electronics space 20 in the garbage can 12. A respective motor 74 rotates the respective roller 60 in a forward direction when the respective motor 74 is actuated to rotate in a first direction. Subsequently the garbage can 12 travels forwardly on the support surface 62 toward a collection spot 76. The respective motor 74 rotates the respective roller 60 in a rearward direction when the respective motor 74 is actuated to rotate in a second direction. Subsequently the garbage can 12 travels rearwardly on the support surface 62 toward a home position 78. Each motor 74 of the plurality of motors 74 may comprise a two direction electric motor or the like.

A camera 80 is coupled to the garbage can 12 and the camera 80 is oriented to point along a direction of travel of the garbage can 12. Furthermore, the camera 80 captures imagery along the direction of travel of the garbage can 12. The camera 80 may comprise a digital video camera or the like. A processor 82 is integrated into the garbage can 12 and the processor 82 is in electrical communication with each motor 74 of the plurality of motors 74. Additionally, the processor 82 is in electrical communication with the camera 80 and the processor 82 is positioned in the electronics space 20 in the garbage can 12.

An electronic memory 84 stores a database comprising an image analysis module 86 and the electronic memory 84 is in electrical communication with the processor 82. The image analysis module 86 analyzes data from the camera 80 to define a route of travel for the garbage can 12. Additionally, the electronic memory 84 is positioned in the electronics space 20 in the garbage can 12. The electronic memory 84 is in electrical communication with the camera 80 to analyze the imagery captured by the camera 80 thereby identifying objects in the imagery. Furthermore, the processor 82 actuates each motor 74 of the plurality of motors 74 to rotate in the first direction according to the route of travel for the garbage can 12. The garbage can 12 automatically travels between the home position 78 and the collection spot 76. Additionally, each motor 74 of the plurality of motors 74 is independently actuatable with respect to each other to steer the garbage can 12 along the route of travel and avoid the objects identified by the image analysis module 86.

A transceiver 88 is integrated into the garbage can 12 and the transceiver 88 is in electrical communication with the processor 82. The transceiver 88 is positioned in the electronics space 20 in the garbage can 12 and the transceiver 88 is in wireless communication with an extrinsic electronic device 90. The extrinsic electronic device 90 communicates operational commands to the processor 82 to remotely control the garbage can 12. Furthermore, the extrinsic electronic device 90 may comprise a smartphone or other type of electronic device that has wireless communication capabilities. The transceiver 88 may comprise a radio frequency transceiver or the like the transceiver 88 may employ Bluetooth communication protocols. The extrinsic electronic device 90 may store a remote control program for programming the garbage can 12 to travel back and forth between the home position 78 and the collection spot 76 at pre-determined times on pre-determined days of the week. Additionally, the remote control program may be employed to steer the garbage can 12 in real time as the garbage can 12 is travelling between the home position 78 and the collection spot 76.

A pair of front motion sensors 92 is provided and each front motion sensor 92 of the pair of front motion sensors 92 is coupled to the front side 22 of the outer wall 14 of the garbage can 12. Each front motion sensor 92 of the pair of front motion sensors 92 senses motion relative to the front side 22. Additionally, each front motion sensor 92 of the pair of front motion sensors 92 is positioned adjacent to the bottom wall 28 of the garbage can 12. Each front motion sensor 92 of the pair of front motion sensors 92 is in electrical communication with the processor 82. The processor 82 de-actuates the plurality of motors 74 when the pair of front motions sensors 92 senses motion to park the garbage can 12 in the collection spot 76. Additionally, each of the pair of front motion sensors 92 may comprise an ultrasonic motion sensor or other type of electronic motion sensor which has an operational range between approximately 1.5 meters and 3.0 meters.

A back motion sensor 94 is provided and the back motion sensor 94 is coupled to the back side 24 of the outer wall 14 of the garbage can 12. Furthermore, the back motion sensor 94 senses motion relative to the back side 24 and he back motion sensor 94 is located adjacent to the bottom wall 28 of the garbage can 12. The back motion sensor 94 is in electrical communication with the processor 82 and the processor 82 de-actuates the plurality of motors 74 when the back motion sensor 94 senses motion. Furthermore, the processor 82 employs the back motion sensor 94 to park the garbage can 12 in the home position 78.

A power supply 96 is integrated into the garbage can 12 and the power supply 96 is in electrical communication with the processor 82. Additionally, the power supply 96 comprises at least one rechargeable battery 98. A charging unit 98 is mountable to a structural support 100 such that the charging unit 98 is elevated above the support surface 62. Furthermore, the charging unit 98 may be located at the home position 78. The charging unit 98 is in electrical communication with a power source 102 and the charging unit 98 broadcasts a charging signal. The power source 102 may comprise a female electrical outlet or the like.

The charging unit 98 has a rear surface 104 and a front surface 106 and an exterior surface 108 extending between the rear surface 104 and the front surface 106. The exterior surface 108 angles inwardly between the rear surface 104 and the front surface 106 and the rear surface 104 has an area that is greater than an area of the front surface 106. The charging unit 98 includes a power cord 105 that extends away from the exterior surface 108 and the power cord 105 has a male plug 107 on a distal end 109 the power cord 105 that is electrically matable to the power source 102. Additionally, the charging unit 98 may be a wireless charger of any conventional design that would commonly be associated with rechargeable electronic devices.

A plurality of charging plates 110 is provided and each charging plate 110 of the plurality of charging plates 110 is coupled to the garbage can 12. Each charging plate 110 of the plurality of charging plates 110 is in electrical communication with the processor 82. Furthermore, a respective one of the charging plates 110 is in wireless communication with the charging unit 98 when the respective charging plate 110 abuts against the charging unit 98 when the garbage can 12 is parked against the charging unit 98. The respective charging plate 110 receives the charging signal from the charging unit 98 for charging the rechargeable battery 98.

Each charging plate 110 of the plurality of charging plates 110 is positioned on a respective one of the back side 24 or the first lateral side 26 or the second lateral side 27 of the outer wall 14 of the garbage can 12. Additionally, each charging plate 110 of the plurality of charging plates 110 which are positioned on the first lateral side 26 and the second lateral side 27 of the outer wall 14 of the garbage can 12 is positioned between a respective one of the pair of cushions 36 and the lid 38. The charging plate 110 which is located on the back side 24 of the outer wall 14 is in wireless communication with the charging unit 98 when the garbage can 12 is parked for charging the rechargeable battery 98.

Each charging plate 110 of the plurality of charging plates 110 has an exterior surface 112 extending between the outer wall 14 of the garbage can 12 and a distal surface 114 of a respective charging plate 110. The exterior surface 112 of the respective charging plate 110 curves inwardly between the outer wall 14 of the garbage can 12 and the distal surface 114 of the respective charging plate 110. Additionally, the distal surface 114 of each charging plate 110 of the plurality of charging plates 110 lies on a plane which is oriented parallel to the respective front side 22 or first lateral side 26 or second lateral side 27 of the outer wall 14 of the garbage can 12. The distal surface 114 of the charging plate 110 which is positioned on the back side 24 of the outer wall 14 of the garbage can 12 abuts the front surface 106 of the charging unit 98 when the garbage can 12 is parked against the charging unit 98.

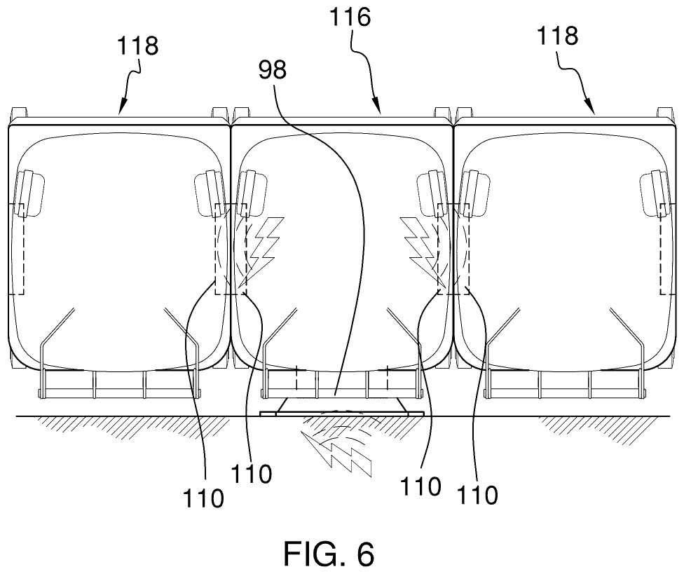

Each charging plate 110 of the plurality of charging plates 110 may comprise a wireless charger of any conventional design commonly associated with rechargeable electronic devices. Additionally, as is shown in FIG. 6, a plurality of garbage cans 12 may be parked next to each other and each of the charging plates 110 which are located on the first lateral side 26 and the second lateral side 27 of the outer wall 14 on a middle garbage can 116 are in wireless communication with a respective charging plate 110 that is positioned on a respective one of the first lateral side 26 or second lateral side 27 of the outer wall 14 of adjacent garbage cans 118 to daisy chain the adjacent garbage cans 118 to the middle garbage can 116. Furthermore, the charging plate 110 on the middle garbage can 12 is in wireless communication with the charging unit 98 such that rechargeable battery 98 in each of the plurality of garbage cans 12 is wirelessly charged.

In use, the extrinsic electronic device 90 is synchronized with the transceiver 88 to enable the garbage can 12 to be remotely controlled with the extrinsic electronic device 90. The motors 74 in the garbage can 12 automatically drive the garbage can 12 to the collection spot 76 such that the garbage can 12 may be emptied by a garbage collection service. The motors 74 in the garbage can 12 automatically drive the garbage can 12 to the home position 78 when the garbage can 12 has been emptied. The charging plate 110 that is located on the back side 24 of the outer wall 14 of the garbage can 12 abuts the charging unit 98 when the garbage can 12 is parked at the home position 78. Furthermore, the charging unit 98 wirelessly charges the rechargeable battery 98 while the garbage can 12 is parked at the home position 78. The image analysis module 86 enables the garbage can 12 to steer itself around obstacles that are identified on the travel route and to identify the collection spot 76. The garbage can 12 may travel back and forth between the home position 78 and the collection spot 76 according to predetermined times on predetermined days that were chosen with the remote control program stored in the extrinsic electronic device 90 or the garbage can 12 may be manually controlled in real time with the remote control program.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated garbage can device for automatically transporting garbage to a pickup location, said device comprising:
a garbage can having an outer wall defining an interior space of said garbage can wherein said interior space is configured to contain a garbage bag, said garbage can having an electronics space being defined beneath said interior space, said electronics space being fluidly discrete from said interior space;
a lid being hingedly coupled to said garbage can, said lid being positionable between an open position exposing said interior space of said garbage can or a closed position closing said interior space;
a plurality of rollers, each roller of said plurality of rollers being rotatably coupled to said garbage can wherein each roller of said plurality of rollers is configured to roll along a support surface to transport said garbage can along the support surface;
a plurality of motors, each motor of said plurality of motors being integrated into said garbage can, each motor of said plurality of motors being positioned in said electronics space in said garbage can, each motor of said plurality of motors being in mechanical communication with a respective one of said plurality of rollers, a respective motor rotating said respective roller in a forward direction when said respective motor is actuated to rotate in a first direction wherein said garbage can is configured to travel forwardly on the support surface toward a collection spot, said respective motor rotating said respective roller in a rearward direction when said respective motor is actuated to rotate in a second direction wherein said garbage can is configured to travel rearwardly on the support surface toward a home position;
a camera being coupled to said garbage can, said camera being oriented to point along a direction of travel of said garbage can wherein said camera is configured to capture imagery along said direction of travel of said garbage can;
a processor being integrated into said garbage can, said processor being positioned in said electronics space in said garbage can, said processor being in electrical communication with each motor of said plurality of motors, said processor being in electrical communication with said camera;
an electronic memory being integrated into said garbage can, said electronic memory being positioned in said electronics space in said garbage can, said electronic memory storing a database comprising an image analysis module, said electronic memory being in electrical communication with said processor, said image analysis module analyzing data from said camera to define a route of travel for said garbage can;
a charging unit being mountable to a structural support wherein said charging unit is configured to be elevated above the support surface at said home position, said charging unit being in electrical communication with a power source, said charging unit broadcasting a charging signal; and
a plurality of charging plates, each charging plate of said plurality of charging plates being coupled to said garbage can, each charging plate of said plurality of charging plates being in electrical communication with said processor, a respective one of said charging plates being in wireless communication with said charging unit when said respective charging plate abuts against said charging unit, said respective charging plate receiving said charging signal from said charging unit for charging said garbage can.

2. The device according to claim 1, further comprising:
said outer wall having a front side and a back side and a first lateral side and a second lateral side;
said garbage can having a bottom wall;
said interior space having a lower bounding surface; and
said lower bounding surface being spaced upwardly from said bottom wall.

3. The device according to claim 2, further comprising:
said lower bounding surface having a first side intersecting a second side;
said first side sloping downwardly from said first lateral side of said outer wall toward said bottom wall;
said second side sloping downwardly from said second lateral side of said outer wall toward said bottom wall; and
said first side and said second side intersecting at a point which extends between said front side and said back side of said outer wall.

4. The device according to claim 2, further comprising said electronics space being defined between said bottom wall and said lower bounding surface of said interior space.

5. The device according to claim 2, further comprising:
a pair of cushions;
each cushion of said pair of cushions being integrated into said outer wall of said garbage can;
each cushion of said pair of cushions being positioned on a respective one of said first lateral side or said second lateral side of said outer wall;
each cushion of said pair of cushions extending partially around said front side and said back side of said outer wall of said garbage can; and
each cushion of said pair of cushions being oriented to extend along a line being oriented parallel to said bottom wall of said garbage can.

6. The device according to claim 5, further comprising each cushion of said pair of cushions being comprised of a resiliently compressible material wherein each cushion of said pair of cushions is configured to absorb impact energy when said garbage can strikes against an object.

7. The device according to claim 2, further comprising:
said lid having a top surface and an outer edge;
said outer edge having a first sidelong side and a second sidelong side each extending between a forward side and a rear side;
said lid including a plurality of hinges;
each hinge of said plurality of hinges including a first portion being coupled to said top surface of said lid and a second portion being coupled to said back side of said outer wall of said garbage can; and
said first portion of each hinge of said plurality of hinges extending away from said rear side of said outer edge of said lid.

8. The device according to claim 7, further comprising:
a pair of lid handles;
each lid handle of said pair of lid handles being coupled to said lid for opening or closing said lid;
each lid handle of said pair of lid handles being positioned on said top surface of said lid;
each lid handle of said pair of lid handles being positioned adjacent to a respective one of said first sidelong side and said second sidelong side of said outer edge of said lid;
each lid handle of said pair of lid handles being positioned proximate an intersection between said forward side of said outer edge of said lid and said respective first sidelong side or said second sidelong side of said outer edge of said lid; and
said pair of lid handles being oriented to angle toward each other.

9. The device according to claim 2, further comprising:
said outer wall of said garbage can having a plurality of wheels wells;
each wheel well of said plurality of wheel wells being recessed into a respective one of said first lateral side and said second lateral side of said outer wall of said garbage can;
each wheel well of said plurality of wheels wells intersecting a respective one of said front side and said back side of said outer wall of said garbage can;
each wheel well of said plurality of wheel wells having a bounding surface; and
said bounding surface curving between said bottom wall of said garbage can and said respective front side or said back side of said outer wall of said garbage can.

10. The device according to claim 9, further comprising:
each roller of said plurality of rollers being located in a respective one of said plurality of wheel wells;
each roller of said plurality of rollers having a rolling surface;
said rolling surface of a respective roller being continuously arcuate about a rotational axis of said respective roller wherein said rolling surface is configured to roll along the support surface; and
said rolling surface of each roller of said plurality of rollers being oriented co-arcuate with said bounding surface of said respective wheel well.

11. The device according to claim 10, further comprising:
a plurality of axles;
each axle of said plurality of axles being rotatably coupled between said outer wall of said garbage can and a respective one of said plurality of rollers;
each axle of said plurality of axles being spaced upwardly from said bottom wall of said garbage can;
said rolling surface of each roller of said plurality of rollers curving downwardly beyond said bottom wall of said garbage can wherein said bottom wall is configured to be elevated above the support surface;
each axle of said plurality of axles having a rotational axis being oriented parallel to said bottom wall of said garbage can; and
each axle of said plurality of axles defining said rotational axis of said respective roller.

12. The device according to claim 11, further comprising:
a plurality of shock absorbers;
each shock absorber of said plurality of shock absorbers being integrated into said bottom wall of said garbage can;
each shock absorber of said plurality of shock absorbers being coupled to a respective one of said plurality of axles;
each shock absorber of said plurality of shock absorbers being oriented perpendicular to said bottom wall of said garbage can; and
each axle of said plurality of axles being movably upwardly or downwardly on said garbage can wherein said plurality of shock absorbers is configured to reduce bouncing when said plurality of rollers either rolls over objects on the support surface or rolls through depressions on the support surface.

13. The device according to claim 1, further comprising:
said electronic memory being in electrical communication with said camera wherein said image analysis module is configured to analyze the imagery captured by said camera thereby identifying objects in the imagery;
said processor actuating each motor of said plurality of motors to rotate in said first direction according to said route of travel for said garbage can wherein said garbage can is configured to automatically travel between said home position and said collection spot; and
each motor of said plurality of motors being independently actuatable with respect to each other wherein said processor is configured to steer said garbage can along said route of travel and avoid the objects identified by said image analysis module.

14. The device according to claim 1, further comprising:
a transceiver being integrated into said garbage can;
said transceiver being in electrical communication with said processor;
said transceiver being positioned in said electronics space in said garbage can; and
said transceiver being in wireless communication with an extrinsic electronic device wherein said extrinsic electronic device is configured to communicate operational commands to said processor to remotely control said garbage can.

15. The device according to claim 2, further comprising:
a pair of front motion sensors;
each front motion sensor of said pair of front motion sensors being coupled to said front side of said outer wall of said garbage can wherein said each front motion sensor of said pair of front motion sensors is configured to sense motion relative to said front side;
each front motion sensor of said pair of front motion sensors being positioned adjacent to said bottom wall of said garbage can;
each front motion sensor of said pair of front motion sensors being in electrical communication with said processor; and
said processor de-actuating said plurality of motors when said pair of front motions sensors senses motion wherein said processor is configured to park said garbage can in said collection spot.

16. The device according to claim 2, further comprising:
a back motion sensor being coupled to said back side of said outer wall of said garbage can wherein said back motion sensor is configured to sense motion relative to said back side;
said back motion sensor being located adjacent to said bottom wall of said garbage can;
said back motion sensor being in electrical communication with said processor; and
said processor de-actuating said plurality of motors when said back motion sensor senses motion wherein said processor is configured to park said garbage can in said home position.

17. The device according to claim 2, further comprising:
a power supply being integrated into said garbage can;
said power supply being in electrical communication with said processor;
said power supply being positioned in said electronics space in said garbage can;
said power supply comprising at least one rechargeable battery;
each charging plate of said plurality charging plates being positioned on a respective one of said back side or said first lateral side or said second lateral side of said outer wall of said garbage can;
each charging plate of said plurality of charging plates which are positioned on said first lateral side and said second lateral side of said outer wall of said garbage can being positioned between a respective one of said pair of cushions and said lid;
said charging plate which is located on said back side being in wireless communication with said charging unit when said garbage can is parked for charging said rechargeable battery.

18. The device according to claim 2, further comprising:
each charging plate of said plurality of charging plates having an exterior surface of said charging plates extending between said outer wall of said garbage can and a distal surface of a respective charging plate;
said exterior surface of said respective charging plate curving inwardly between said outer wall of said garbage can and said distal surface of said respective charging plate;
said distal surface of each charging plate of said plurality of charging plates lying on a plane being oriented parallel to said respective front side or first lateral side or second lateral side of said outer wall of said garbage can;
said charging unit having a rear surface and a front surface and an exterior surface extending between said rear surface and said front surface;
said exterior surface curving inwardly between said rear surface and said front surface;
said rear surface having an area being greater than an area of said front surface; and
said distal surface of said charging plate which is positioned on said back side of said outer wall of said garbage can abutting said front surface of said charging unit when said garbage can is parked against said charging unit.

19. An automated garbage can device for automatically transporting garbage to a pickup location, said device comprising:
a garbage can having an outer wall defining an interior space of said garbage can wherein said interior space is configured to contain a garbage bag, said garbage can having an electronics space being defined beneath said interior space, said electronics space being fluidly discrete from said interior space, said outer wall having a front side and a back side and a first lateral side and a second lateral side, said garbage can having a bottom wall, said interior space having a lower bounding surface, said lower bounding surface being spaced upwardly from said bottom wall, said lower bounding surface having a first side intersecting a second side, said first side sloping downwardly from said first lateral side of said outer wall toward said bottom wall, said second side sloping downwardly from said second lateral side of said outer wall toward said bottom wall, said first side and said second side intersecting at a point which extends between said front side and said back side of said outer wall, said electronics space being defined between said bottom wall and said lower bounding surface of said interior space;
a pair of cushions, each cushion of said pair of cushions being integrated into said outer wall of said garbage can, each cushion of said pair of cushions being positioned on a respective one of said first lateral side or said second lateral side of said outer wall, each cushion of said pair of cushions extending partially around said front side and said back side of said outer wall of said garbage can, each cushion of said pair of cushions being oriented to extend along a line being oriented parallel to said bottom wall of said garbage can, each cushion of said pair of cushions being comprised of a resiliently compressible material wherein each cushion of said pair of cushions is configured to absorb impact energy when said garbage can strikes against an object;
a lid being hingedly coupled to said garbage can, said lid being positionable between an open position exposing said interior space of said garbage can or a closed position closing said interior space, said lid having a top surface and an outer edge, said outer edge having a first sidelong side and a second sidelong side each extending between a forward side and a rear side, said lid including a plurality of hinges, each hinge of said plurality of hinges including a first portion being coupled to said top surface of said lid and a second portion being coupled to said back side of said outer wall of said garbage can, said first portion of each hinge of said plurality of hinges extending away from said rear side of said outer edge of said lid;
a pair of lid handles, each lid handle of said pair of lid handles being coupled to said lid for opening or closing said lid, each lid handle of said pair of lid handles being positioned on said top surface of said lid, each lid handle of said pair of lid handles being positioned adjacent to a respective one of said first sidelong side and said second sidelong side of said outer edge of said lid, each lid handle of said pair of lid handles being positioned proximate an intersection between said forward side of said outer edge of said lid and said respective first sidelong side or said second sidelong side of said outer edge of said lid, said pair of lid handles being oriented to angle toward each other;
a plurality of rollers, each roller of said plurality of rollers being rotatably coupled to said garbage can wherein each roller of said plurality of rollers is configured to roll along a support surface to transport said garbage can along the support surface, said outer wall of said garbage can having a plurality of wheels wells, each wheel well of said plurality of wheel wells being recessed into a respective one of said first lateral side and said second lateral side of said outer wall of said garbage can, each wheel well of said plurality of wheels wells intersecting a respective one of said front side and said back side of said outer wall of said garbage can, each wheel well of said plurality of wheel wells having a bounding surface, said bounding surface curving between said bottom wall of said garbage can and said respective front side or said back side of said outer wall of said garbage can, each roller of said plurality of rollers being located in a respective one of said plurality of wheel wells, each roller of said plurality of rollers having a rolling surface, said rolling surface of a respective roller being continuously arcuate about a rotational axis of said respective roller wherein said rolling surface is configured to roll along the support surface, said rolling surface of each roller of said plurality of rollers being oriented co-arcuate with said bounding surface of said respective wheel well;
a plurality of axles, each axle of said plurality of axles being rotatably coupled between said outer wall of said garbage can and a respective one of said plurality of rollers, each axle of said plurality of axles being spaced upwardly from said bottom wall of said garbage can, said rolling surface of each roller of said plurality of rollers curving downwardly beyond said bottom wall of said garbage can wherein said bottom wall is configured to be elevated above the support surface, each axle of said plurality of axles having a rotational axis being oriented parallel to said bottom wall of said garbage can, each axle of said plurality of axles defining said rotational axis of said respective roller;
a plurality of shock absorbers, each shock absorber of said plurality of shock absorbers being integrated into said bottom wall of said garbage can, each shock absorber of said plurality of shock absorbers being coupled to a respective one of said plurality of axles, each shock absorber of said plurality of shock absorbers being oriented perpendicular to said bottom wall of said garbage can, each axle of said plurality of axles being movably upwardly or downwardly on said garbage can wherein said plurality of shock absorbers is configured to reduce bouncing when said plurality of rollers either rolls over objects on the support surface or rolls through depressions on the support surface;
a plurality of motors, each motor of said plurality of motors being integrated into said garbage can, each motor of said plurality of motors being in mechanical communication with a respective one of said plurality of rollers, each motor of said plurality of motors being positioned in said electronics space in said garbage can, a respective motor rotating said respective roller in a forward direction when said respective motor is actuated to rotate in a first direction wherein said garbage can is configured to travel forwardly on the support surface toward a collection spot, said respective motor rotating said respective roller in a rearward direction when said respective motor is actuated to rotate in a second direction wherein said garbage can is configured to travel rearwardly on the support surface toward a home position;
a camera being coupled to said garbage can, said camera being oriented to point along a direction of travel of said garbage can wherein said camera is configured to capture imagery along said direction of travel of said garbage can;
a processor being integrated into said garbage can, said processor being positioned in said electronics space in said garbage can, said processor being in electrical communication with each motor of said plurality of motors, said processor being in electrical communication with said camera;
an electronic memory storing a database comprising an image analysis module, said electronic memory being in electrical communication with said processor, said image analysis module analyzing data from said camera to define a route of travel for said garbage can, said electronic memory being in electrical communication with said camera wherein said image analysis module is configured to analyze the imagery captured by said camera thereby identifying objects in the imagery, said electronic memory being positioned in said electronics space in said garbage can, said processor actuating each motor of said plurality of motors to rotate in said first direction according to said route of travel for said garbage can wherein said garbage can is configured to automatically travel between said home position and said collection spot, each motor of said plurality of motors being independently actuatable with respect to each other wherein said processor is configured to steer said garbage can along said route of travel and avoid the objects identified by said image analysis module;
a transceiver being integrated into said garbage can, said transceiver being in electrical communication with said processor, said transceiver being in wireless communication with an extrinsic electronic device wherein said extrinsic electronic device is configured to communicate operational commands to said processor to remotely control said garbage can;
a pair of front motion sensors, each front motion sensor of said pair of front motion sensors being coupled to said front side of said outer wall of said garbage can wherein said each front motion sensor of said pair of front motion sensors is configured to sense motion relative to said front side, each front motion sensor of said pair of front motion sensors being positioned adjacent to said bottom wall of said garbage can, each front motion sensor of said pair of front motion sensors being in electrical communication with said processor, said processor de-actuating said plurality of motors when said pair of front motions sensors senses motion wherein said processor is configured to park said garbage can in said collection spot;
a back motion sensor being coupled to said back side of said outer wall of said garbage can wherein said back motion sensor is configured to sense motion relative to said back side, said back motion sensor being located adjacent to said bottom wall of said garbage can, said back motion sensor being in electrical communication with said processor, said processor de-actuating said plurality of motors when said back motion sensor senses motion wherein said processor is configured to park said garbage can in said home position;
a power supply being integrated into said garbage can, said power supply being in electrical communication with said processor, said power supply comprising at least one rechargeable battery;
a charging unit being mountable to a structural support wherein said charging unit is configured to be elevated above the support surface at said home position, said charging unit being in electrical communication with a power source, said charging unit broadcasting a charging signal, said charging unit having a rear surface and a front surface and an exterior surface extending between said rear surface and said front surface, said exterior surface curving inwardly between said rear surface and said front surface, said rear surface having an area being greater than an area of said front surface; and
a plurality of charging plates, each charging plate of said plurality of charging plates being coupled to said garbage can, each charging plate of said plurality of charging plates being in electrical communication with said processor, a respective one of said charging plates being in wireless communication with said charging unit when said respective charging plate abuts against said charging unit when said garbage can is parked against said charging unit, said respective charging plate receiving said charging signal from said charging unit for charging said rechargeable battery, each charging plate of said plurality charging plates being positioned on a respective one of said back side or said first lateral side or said second lateral side of said outer wall of said garbage can, each charging plate of said plurality of charging plates which are positioned on said first lateral side and said second lateral side of said outer wall of said garbage can being positioned between a respective one of said pair of cushions and said lid, said charging plate which is located on said back side being in wireless communication with said charging unit when said garbage can is parked for charging said rechargeable battery, each charging plate of said plurality of charging plates having an exterior surface of said charging plates extending between said outer wall of said garbage can and a distal surface of a respective charging plate, said exterior surface of said respective charging plate curving inwardly between said outer wall of said garbage can and said distal surface of said respective charging plate, said distal surface of each charging plate of said plurality of charging plates lying on a plane being oriented parallel to said respective front side or first lateral side or second lateral side of said outer wall of said garbage can, said distal surface of said charging plate which is positioned on said back side of said outer wall of said garbage can abutting said front surface of said charging unit when said garbage can is parked against said charging unit.
